(19) United States
(12) Patent Application Publication
(10) Pub. No.: US 2008/0198870 A1
(43) Pub. Date: Aug. 21, 2008

(54) NETWORK CONNECTIONS FOR MEDIA PROCESSING DEVICES

(75) Inventors: Rainer Brodersen, San Jose, CA (US); Jeffrey Robbin, Los Altos, CA (US); Patrick E. McClaughry, Sunnyvale, CA (US); Rachel Clare Goldeen, Mountain View, CA (US); Rob Newberry, San Jose, CA (US)

Correspondence Address: FISH & RICHARDSON P.C., PO BOX 1022, MINNEAPOLIS, MN, 55440-1022, US

(73) Assignee: Apple Inc., Cupertino, CA (US)

(21) Appl. No.: 11/676,169

(22) Filed: Feb. 16, 2007

(51) Int. Cl. H04L 12/28

(52) U.S. Cl. 370/465; 370/401

(57) ABSTRACT

A media processing device includes a wireless network interface to establish a wireless network connection and a wired network interface to establish a wired network connection. The wired network connection is established if a network is connected to the wired network interface and the wireless network connection is established if the network is disconnected from the wired network interface.

### BACKGROUND

This disclosure is related to media processing systems and methods.

Media devices and systems, such as digital video and audio players, can include multiple functions and capabilities, such as playing stored content, browsing and selecting from recorded content, storing and/or receiving content selected by a user, and the like. These various functions can often be grouped according to content types, e.g., movies, music, television programs, photos, etc.

### SUMMARY

Disclosed herein are systems and methods for selectively establishing a network connection between a media processing device and a network. A wired network connection is established if a wired network interface, included in the media processing device, is connected to the network. A wireless network connection is established between a wireless network interface, also included in the media processing device, and the network if the wired network interface is disconnected to the network. Addresses may be assigned to the media processing device and protocols may be implemented to establish the network connection.

In other implementations, instructions stored on computer readable media are used to cause a processor to perform the operations comprising: selecting between a wired network interface of a media processing device and a wireless network interface of the media processing device to establish a connection with a network, wherein the selection is based, at least in part, upon determining if the network is connected to the wired network interface.

In another implementation, a media processing device includes a wireless network interface to establish a wireless network connection and a wired network interface to establish a wired network connection. The wired network connection is established if a network is connected to the wired network interface and the wireless network connection is established if the network is disconnected from the wired network interface.

### BRIEF DESCRIPTION OF THE DRAWINGS

FIG. 1 is a block diagram of a media processing device.

FIG. 2 is a block diagram of a media system.

FIG. 3 is a block diagram of an example media processing system.

FIG. 4 is a block diagram of an example remote control device for the media processing system.

FIG. 5 is an example network environment in which a media processing system in accordance with FIG. 1 can be implemented.

FIG. 6 is a flow diagram for a media processing device network connection process.

FIGS. 7-13 are screens used to connect a media processing device to a network.

### DETAILED DESCRIPTION

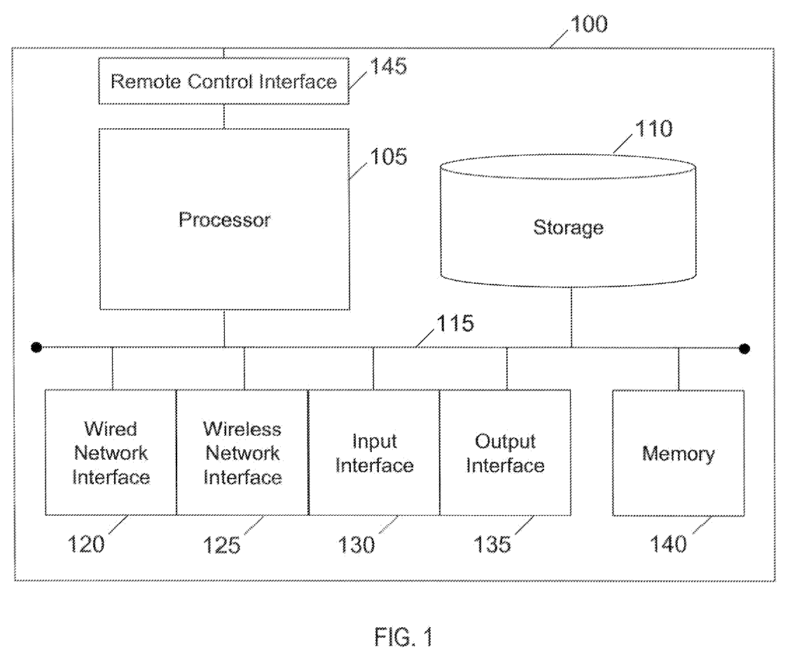

FIG. 1 presents a media processing device 100 that can be configured to present one or more types of media through an output device, including audio, video, images, or any combination thereof. The media processing device 100 includes a processor 105 configured to control the operation of the media processing device 100. For example, the processor 105 can control communications with one or more media servers to receive media for playback. The media can be received through push and/or pull operations, including through downloading and streaming. The processor 105 also can be configured to generate output signals for presentation, such as one or more streams representing media content or an interface for interacting with a user.

The media processing device 100 also includes a storage device 110 that can be configured to store information including media, configuration data, and operating instructions. The storage device 110 can be any type of non-volatile storage, including a hard disk device or a solid-state drive. For example, media received from an external media server can be stored on the storage device 110. The received media thus can be locally accessed and processed. Further, configuration information, such as the resolution of a coupled display device or information identifying an associated media server, can be stored on the storage device 110. Additionally, the storage device 110 can include operating instructions executed by the processor 105 to control operation of the media processing device 100. In one implementation, the storage device 110 can be divided into a plurality of partitions, wherein each partition can be utilized to store one or more types of information and can have custom access control provisions.

A communication bus 115 couples the processor 105 to the other components and interfaces included in the media processing device 100. The communication bus 115 can be configured to permit unidirectional and/or bidirectional communication between the components and interfaces. For example, the processor 105 can retrieve information from and transmit information to the storage device 110 over the communication bus 115. In an implementation, the communication bus 115 may be comprised of a plurality of busses, each of which couples at least one component or interface of the media processing device 100 with another component or interface.

The media processing device 100 also includes a plurality of input and output interfaces for communicating with other devices, including media servers and presentation devices. A wired network interface 120 and a wireless network interface 125 each can be configured to permit the media processing device 100 to transmit and receive information over a network, such as a local area network (LAN) or the Internet. Additionally, an input interface 130 can be configured to receive input from another device through a direct connection, such as a USB or an IEEE 1394 connection. Other types of input interfaces may also be implemented to receive a user input. For example, an input interface may use touch-based operations, near-contact operations or combinations thereof to receive input. For example, an input interface (e.g., a remote control device) may include a proximity detection mechanism that can sense the presence of an input (e.g., a user's finger). As such, a remote control device may sense an input absent user contact with a surface of the remote control device. In some implementations, a user may use a key board and virtually any suitable pointing device (e.g., mouse, track ball, stylus, touch screen, etc.) for interaction. The pointing device can also be operated by a near contact screen that employs a regional sensing field to detect objects in the proximity.

Further, an output interface 135 can be configured to couple the media processing device 100 to one or more external devices, including a television, a monitor, an audio receiver, and one or more speakers. For example, the output interface 135 can include one or more of an optical audio interface, an RCA connector interface, a component video interface, and a High-Definition Multimedia Interface (HDMI). The output interface 135 also can be configured to provide one signal, such as an audio stream, to a first device and another signal, such as a video stream, to a second device. Further, a memory 140, such as a random access memory (RAM) and/or a read-only memory (ROM) also can be included in the media processing device 100. As with the storage device 110, a plurality of types of information, including configuration data and operating instructions, can be stored in the memory 140.

Additionally, the media processing device 100 can include a remote control interface 145 that can be configured to receive commands from one or more remote control devices (not pictured). The remote control interface 145 can receive the commands through wireless signals, such as infrared and radio frequency signals. The received commands can be utilized, such as by the processor 105, to control media playback or to configure the media processing device 100. Similar to the input interface mentioned above, the remote control interface may receive commands from remote control devices that implement touch-based operations, near-contact operations or combinations thereof.

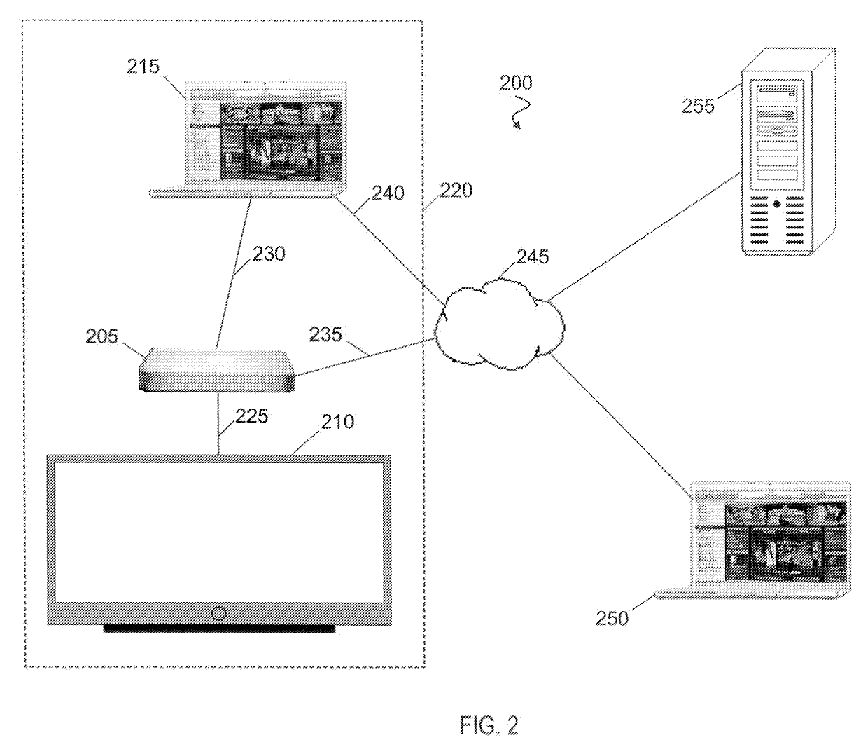

FIG. 2 presents a media system 200 that includes a media processing device 205. The media system 200 includes a host location 220, such as a home or office, in which the media processing device 205 is installed. The host location 220 also can include a local media server 215 and a presentation device, such as a monitor 210. The monitor 210 can be coupled to the media processing device 205 through a media connector 225, such that video and/or audio information output by the media processing device 205 can be presented through the monitor 210. Further, the media processing device 205 can be coupled to the local media server 215 through a local connection 230, such as a wired network connection, a wireless network connection, a direct connection, or other similar connection technique. As such, the media processing device 205 can receive media content from the local media server 215. The local media server 215 can be any computing device, including a personal computer, a server, a palm top computer, or a media device capable of storing and/or playing back media content.

Further, the media processing device 205 and the local media server 215 can include network connections 235 and 240 respectively, which provide access to a network 245, such as the Internet. In one implementation, the media processing device 205 can communicate with a remote media server 250 and/or a media store 255 over the network 245. For example, a connection can be established between the media processing device 205 and the remote media server 250. The connection can be secure or un-secure. Thereafter, the media processing device 205 can receive media content from the remote media server 250, such as by streaming or downloading.

Similarly, the media processing device 205 can be configured to receive media content from a media store 255. For example, upon establishing a connection, the media processing device 205 can request a list of available media content from the media store 255. The list of available media content can include free content, such as trailers and pod casts, and for-purchase content, such as movies, television programs, and music. Additionally, the media processing device 205 can be configured to communicate with the media store 255 to validate media content, such as by verifying digital rights management information. Other types of media devices and systems may also used.

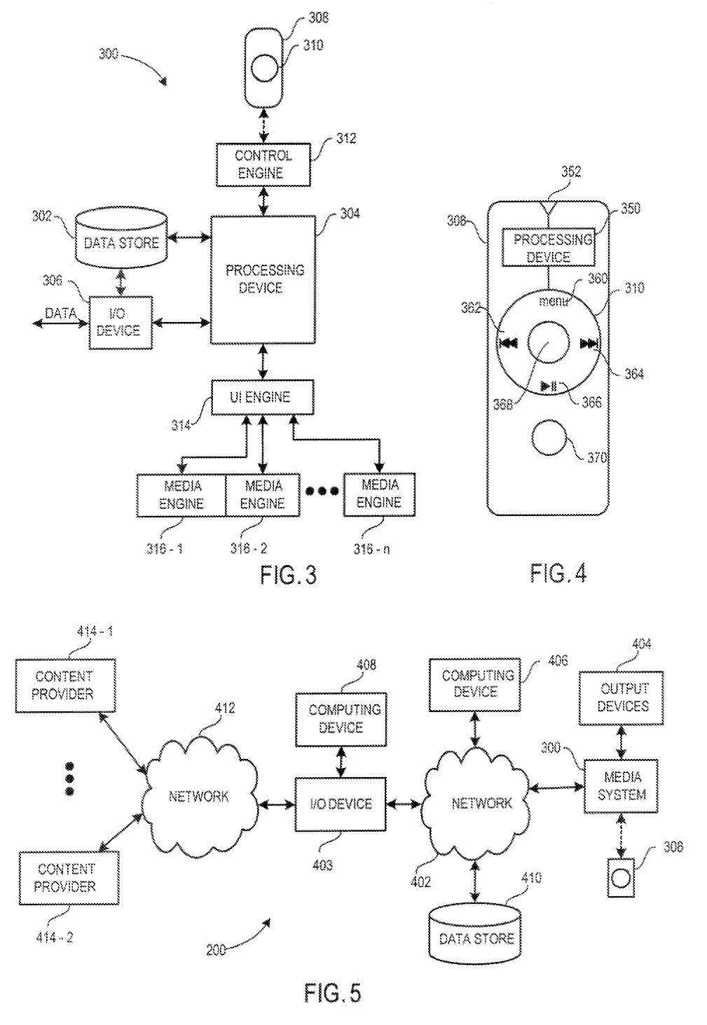

FIG. 3 presents a block diagram of an exemplary media processing system 300. The media processing system 300 can transmit and receive media data and data related to the media data. The media data can be stored in a data store 302, such as a memory device, and be processed by a processing device 304 for output on a display device, such as a television, a computer monitor, a game console, a hand held portable device, and the like, and/or an audio device, such as a multi-channel sound system, a portable media player, a computer system, and the like. The media processing system 300 may be used to process media data, for example, video data and audio data received over one or more networks by an input/output (I/O) device 306. Such media data may include metadata, e.g., song information related to audio data received, or programming information related to a television program received.

The media data and related metadata may be provided by a single provider, or may be provided by separate providers. In one implementation, the media processing system 300 can be configured to receive media data from a first provider over a first network, such as a cable network, and receive metadata related to the video data from a second provider over a second network, such as a wide area network (WAN). Example media data include video data, audio data, content payload data, or other data conveying audio, textual and/or video data.

In another implementation, the media processing system 300 can be configured to receive media data and metadata from a computing device, such as a personal computer. In one example of this implementation, a user manages one or more media access accounts with one or more content providers through the personal computer. For example, a user may manage a personal iTunes® account with iTunes® software, available from Apple Computer, Inc. Media data, such as audio and video media data, can be purchased by the user and stored on the user's personal computer and/or one or more data stores. The media data and metadata stored on the personal computer and/or the one or more data stores can be selectively pushed and/or pulled for storage in the data store 302 of the media processing system 300.

In another implementation, the media processing system 300 can be used to process media data stored in several data stores in communication with a network, such as wired and/or wireless local area network (LAN), for example. In one implementation, the media processing system 300 can pull and/or receive pushed media data and metadata from the data stores over the network for presentation to a user. For example, the media processing system 300 may be implemented as part of an audio and video entertainment center having a video display device and an audio output device, and can pull media data and receive pushed media data from one or more data stores for storage and processing. At the entertainment center, a user can, for example, view photographs that are stored on a first computer while listening to music files that are stored on a second computer.

In one implementation, the media processing system 300 includes a remote control device 308. The remote control device 308 can include a rotational input device 310 configured to sense touch actuations and generate remote control signals therefrom. The touch actuations can include rotational actuations, such as when a user touches the rotational input device 310 with a digit and rotates the digit on the surface of the rotational input device 310. The touch actuations can also include click actuations, such as when a user presses on the rotational input device 310 with enough pressure to cause the remote control device 308 to sense a click actuation.

In one implementation, the functionality of the media processing system 300 is distributed across several engines. For example, the media processing system 300 may include a controller engine 312, a user interface (UI) engine 314, and one or more media engines 316-1, 316-2, and 316-n. The engines may be implemented in software as software modules or instructions, or may be implemented in hardware, or in a combination of software and hardware.

The control engine 312 is configured to communicate with the remote control device 308 by a link, such as a wireless infrared signal or radio frequency signal. The remote control device 308 can transmit remote control signals generated, for example, from touch actuations of the rotational input device 310 to the control engine 312 over the link. In response, the control engine 312 is configured to receive the remote control signals and generate control signals in response. The control signals are provided to the processing device 304 for processing.

The control signals generated by the control engine 312 and processed by the processing device 304 can invoke one or more of the UI engine 314 and media engines 316-1-316-n. In one implementation, the UI engine 314 manages a user interface to facilitate data presentation for the media engines 316-1-316-n and functional processing in response to user inputs.

In one implementation, the media engines 316 can include one or more content-specific engines, such as a movies engine, television program engine, music engine, and the like. Each engine 316 can be instantiated to support content-specific functional processing. For example, a movie engine to support movie-related functions can be instantiated by selecting a “Movies” menu item. Example movie-related functions include purchasing movies, viewing movie previews, viewing movies stored in a user library, and the like. Likewise, a music engine to support music-related functions can be instantiated by selecting a “Music” menu item. Example music-related functions include purchasing music, viewing music playlists, playing music stored in a user library, and the like.

The media processing system 300 of FIG. 3 can also implement different functional distribution architectures that have additional functional blocks or fewer functional blocks. For example, the engines 316 can be implemented in a single monolithic engine.

FIG. 4 is a block diagram of an example remote control device 308 for the media processing system 300. The remote control device 308 includes a rotational input device 310, a processing device 350, and a wireless communication subsystem 352. The rotational input device 310 defines a surface that can sense a touch actuation, such as the presence of a finger on the surface, and can further generate a control signal based on a rotation of the finger on the surface. In one implementation, a touch sensitive array is disposed beneath the surface of the rotational input device 310. The touch sensitive array can be disposed according to polar coordinates, i.e., r and Θ, or can be disposed according to Cartesian coordinates, i.e., x and y, or other similar coordinate system.

The rotational input device areas 360, 362, 364, 366 and 368 are receptive to press actuations. In one implementation, the areas include a menu area 360, a reverse/previous area 362, a play/pause area 364, a forward/next area 366, and a select area 368. The areas 360-368, in addition to generating signals related to their descriptive functionalities, can also generate signals for context-dependent functionality. For example, the menu area 360 can generate signals to support the functionality of dismissing an onscreen user interface, and the play/pause area 364 can generate signals to support the function of drilling down into a hierarchal user interface. In one implementation, the areas 360-368 comprise buttons disposed beneath the surface of the rotational input device 310. In another implementation, the areas 360-368 comprise pressure sensitive actuators disposed beneath the surface of the rotational input device 310.

The processing device 350 is configured to receive the signals generated by the rotational input device 310 and generate corresponding remote control signals in response. The remote control signals can be provided to the communication subsystem 352, which can wirelessly transmit the remote control signals to the media processing system 300.

Although shown as comprising a circular surface, in another implementation, the rotational input device 310 can comprise a rectangular surface, a square surface, or some other shaped surface. Other surface geometries that accommodate pressure sensitive areas and that can sense touch actuations may also be used, e.g., an oblong area, an octagonal area, etc.

Other actuation area configurations may also be used. For example, in another implementation, the remote control device 308 can also include a separate actuation button 370. In this implementation, the areas comprise a “+” or increase area 360, a reverse/previous area 362, a “−” or decrease area 364, a forward/next area 366, a play/pause area 368, and a menu area 370.

FIG. 5 is an example network environment 400 in which a media processing system 300 in accordance with FIG. 3 may be implemented. The media processing system 300 receives, for example, user input through a remote control device 308 and media data over a network 402, such as a wired or wireless LAN. In one implementation, the network 402 communicates with a wide area network 412, such as the Internet, through an I/O device 403, such as a router, server, cable modem, or other computing and/or communication processing device. The media processing system 300 processes the media data for output to one or more output devices 404. The media processing system 300 can receive the media data from one or more data stores connected to the network 402, such as computing devices 406 and 408, and a data store 410.

The media data can be received through the network 412 by one of the computing devices, such as computing device 408. The network 412 can include one or more wired and wireless networks, such as the Internet. The media data is provided by one or more content providers 414. For example, the content provider 414-1 may provide media data that is processed by the media processing system 300 and output through the output devices 404, and the content provider 414-2 may provide metadata related to the media data for processing by the media processing system 300. Such metadata may include episodic content, artist information, and the like. A content provider 414 can also provide both media data and related metadata.

In one implementation, the media processing system 300 can also communicate with one or more content providers 414 directly. For example, the media processing system 300 can communicate with the content providers the wireless network 402, the I/O device 403, and the network 412. The media processing system 300 can also communicate with the content providers 414 thorough other network configuration, e.g., through a direct connection to a cable modem, through a router, or through one or more other communication devices. Example communications can include receiving sales information, preview information, or communications related to commercial transactions, such as purchasing audio files and video files.

In another implementation, the media processing system 300 can receive content from any of the computing devices 406 and 408, and other such computing devices or data stores 410 available on the network 402 through sharing. Thus, if any one or more of the computing devices or data stores are unavailable, media data and/or meta data one the remaining computing devices or other such computing devices or data stores can still be accessed.

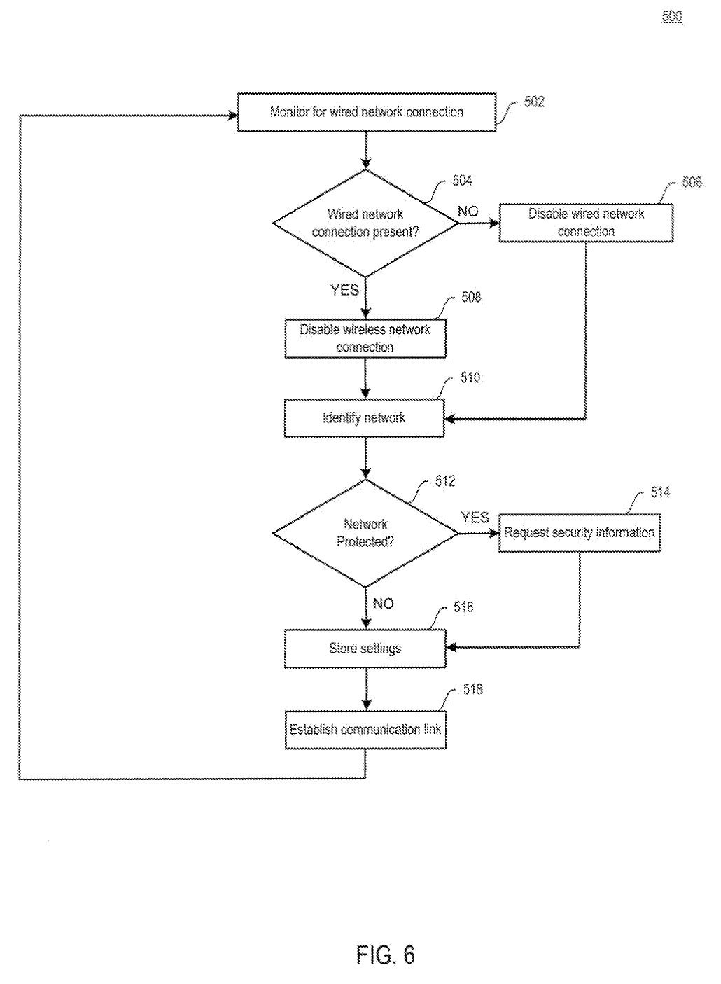

FIG. 6 shows a flow diagram 500 of an exemplary process for establishing a network connection between a media processing device (or system) and a network. Briefly referring back to FIG. 2, the media processing device 205 may establish a network connection to the local media server 215 (via local connection 230) and to the network 245 (via network connection 235). Either of the network connections may be implemented using wired techniques, wireless techniques or other similar techniques or combination or techniques.

Referring also back to FIG. 1, wired network interface 120 and wireless network interface 125 may be used to establish a network connection between the media processing device 205 and the network 245 (or local media server 215). For example, the media processing device 205 may selectively use these two interfaces to establish a network connection. Interface selection may include determining if a wired connector (e.g., an Ethernet connection) has been connected to the media processing device. For example, if the media processing device 205 detects the presence of a wired connector connected to the wired network interface 120, the wired connection may be used to establish a network connection with, for example, the local media server 215, the network 245, etc. If a wired connection is absent, the wireless network interface 125 may be used to establish a network connection. By using this procedure, the media processing device 205 is capable of automatically determining whether to establish a wired or wireless network connection based upon the presence of a wired connection with the media processing device. Furthermore, by storing settings associated with wired and wireless network connections, the media processing device 205 may toggle between a wired network connection and a wireless network connection based upon the wired connector being connected to and disconnected from the media processing device.

Referring back to FIG. 6, operations of the process include monitoring the media processing device 205 for a wired network connection in step 502. For example, a socket or other type of mechanical connector of the media processing device 205 may be monitored for the presence of an inserted connector (e.g., an Ethernet connector). Electrical monitoring may also be implemented individually or in combination with mechanical monitoring to determine if a wired network connection is present. For example, electrical signals, electrical loading, or other electrical phenomena associated with a hardwire network connection may be monitored. Based upon monitoring for the presence of a wired network connector, the process determines if a wired network connection is present in step 504.

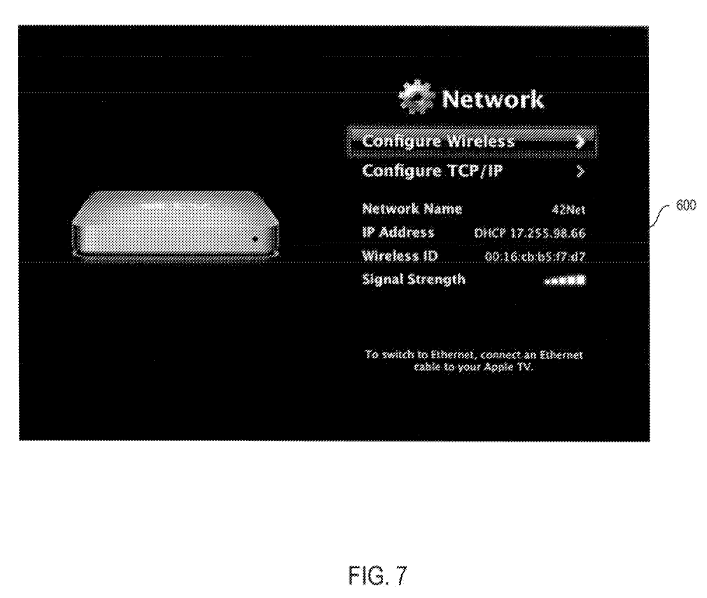

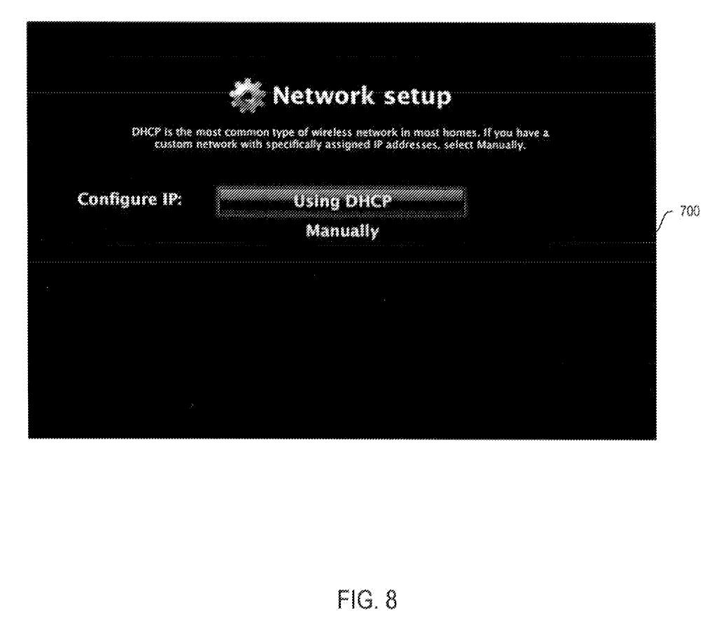

If a wired network connection is present, the process disables any previously established wireless network connection (in step 508) and uses the wired network connection to establish a communication link. Alternatively, if a wired network connection is absent, the process disables any previously established wired network connection (in step 506) and uses the wireless network connection to establish a communication link. In some arrangements, the media processing device 205 may present information on a display device (e.g., a television, a computer monitor, a game console, a hand held portable device, etc.) that describes the current wired or wireless network connection. For example, in FIG. 7, a screen 600 is shown that presents network information such as the name of a connected network, an address (e.g., Internet Protocol (IP) address) assigned to the media processing device 205, a wireless identification number associated with the connection (for a wireless network connection) and a graphical representation of signal strength. The screen 600 also includes user-selectable buttons that provide a link to other screens for configuring settings for wired and wireless network connections (e.g., Transmission Control Protocol/Internet Protocol (TCP/IP) settings). In this illustration, information associated with a wireless network connection is presented, however, wired network connection information may also be presented. Instructions may also be presented, for example, as provided in the lower right corner of the screen 600, a wired network connection (e.g., an Ethernet connection) may be established by connecting a wired connector (e.g., an Ethernet connector and cable) to the media processing device 205.

Upon determining if a wired connector is connected to the media processing device 205, and thereby determine whether to establish a wired or wireless network connection, the process identifies the network in step 510. One or more operations may be executed for network identification. For example, an address may be assigned to the media processing device 205 or a previously assigned address may be identified. A network may also be selected to establish a wired or wireless connection with the media processing device 205. For a wired connection, typically one network connects to the media processing device 205, however, in some scenarios one network may be selected from a list of networks connected by the wired network connection. Similarly, one of numerous wireless networks may be selected for a wireless connection with the media processing device 205.

Address assignment may be provided, for example, from the connected network, a device connected to the network or manually by a user. In FIG. 8, a screen 700 is shown that allows a user to select between two methodologies for assigning an address (e.g., an IP address) to the media processing device 205. In this example, user-selectable button may be used to determine if an address has been automatically assigned. For example, the media processing device 205 may dynamically be assigned an address upon connecting to a network. A computing device (e.g., a server) connected to the network may utilize a protocol such as the Dynamic Host Configuration Protocol (DHCP) for address assignment. During each instance that the media processing device 205 connects to the wired or wireless network, the DHCP server automatically assigns an address and sends the address to the media processing device. The screen 700 also includes a user-selectable button that may be used to initiate manual entry of an address for assignment to the media processing device. In some arrangements, manual address entry may be triggered if the presence of a network is undetected after address assignment from a DHCP server. For example, if the media processing device 205 does not detect the presence of a network during a predefined time period (after being assigned an address by a DHCP server), manual entry of an address may be requested.

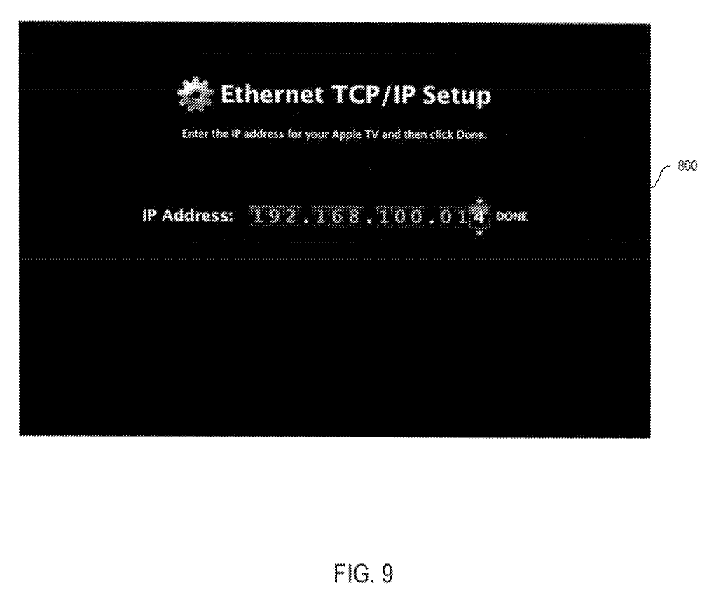

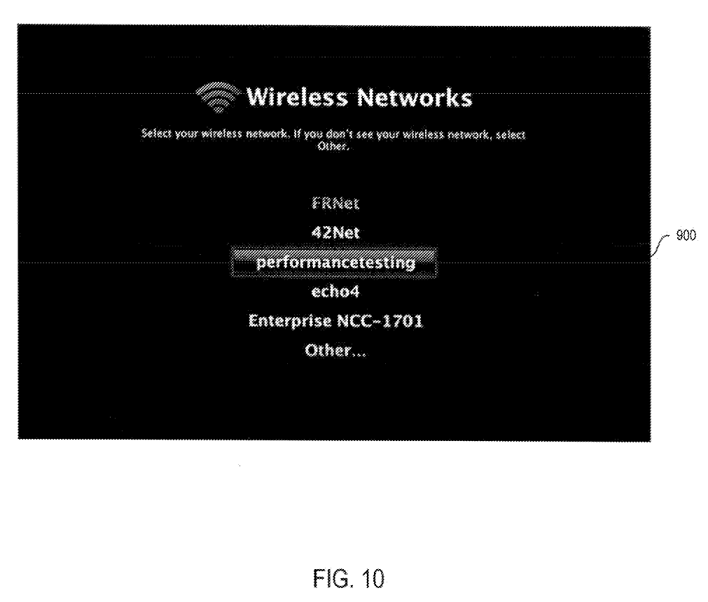

In FIG. 9, a screen 800 is shown that allows a user to manually enter an address for the media processing device 205. In this example, a twelve digit address (e.g., four three digit segments) is entered by the user, however, in other arrangements more or less digits (or other alphanumerical characters, symbols, etc.) may be entered to define the assigned address. One or more types of input devices may be used to enter the address such as a keyboard (not shown) connected to the input interface 130 may provide digits from the user along with navigational commands for moving among the twelve digit entry locations (and a exit button labeled “done”). A remote control may also be used (via remote control interface 145) for entering the digits and navigational commands. For example, “left” and “right” buttons on a remote control may be used to navigate among the twelve digit entry locations and “up” and “down” buttons may be used to select the digit values (e.g., “0”, “1”, . . . “9”). An “enter” button may be used to finalize a selection.

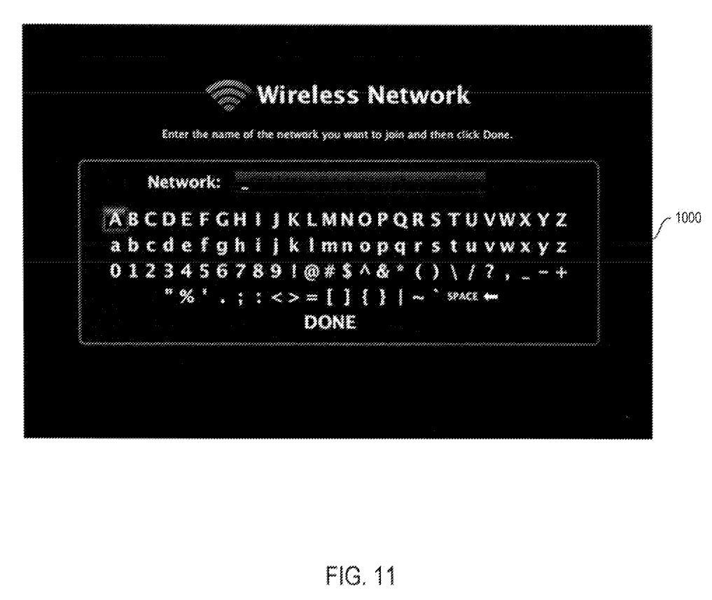

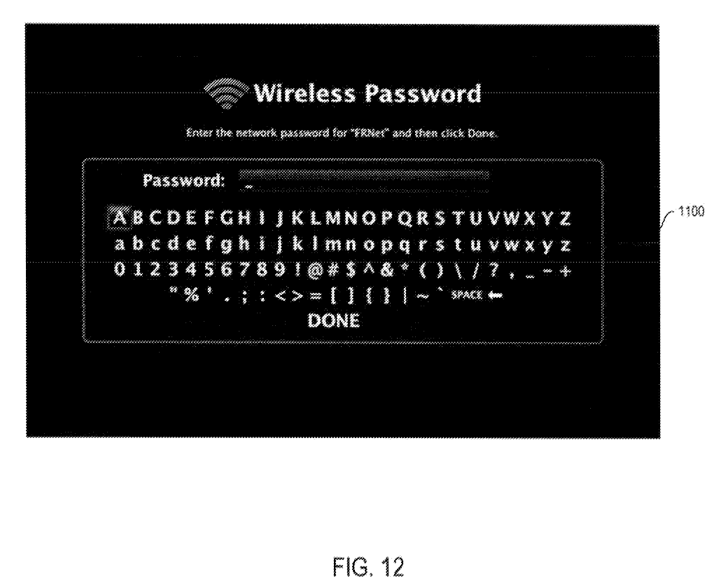

Upon assigning an address to the media processing device 205, identification of the network (step 510) may also include selecting a network. Typically, a wired network connection (e.g., Ethernet connection) connects to a single network while a wireless network connection allows the media processing device 205 to connect with one of multiple wireless networks. In FIG. 10, a screen 900 is shown (that may be presented on the display device) for allowing a user to select one wireless network from a list of multiple wireless networks. In some arrangements, each of the wireless network list entries are detected by the media processing device 205 and may be selected by with a remote control (via remote control interface 145) or another input device (e.g., a keyboard, touch-screen) via the input interface 130. By selecting the list entry labeled “other”, a user may also identify another wireless network (not included in the list) for selection. In FIG. 11, a screen 1000 is shown that allows a user to identify one or more wireless networks (not included in the list of screen 900) for selection and to establish a wireless network connection. The screen 1000 includes menu of alphanumerical characters and symbols that may be selected to identify the name of a wireless network. Character selection and navigation may be provided by “up”, “down”, left”, “right” and “enter” keys of a remote control in communication with the remote control interface 145. Selection and navigation may also be provided by a keyboard, a touch-screen device, or other type of input device in communication with the input interface 130. Upon entering the name of the wireless network, the “DONE” label button may be selected by the user. If detected and recognized by the media processing device 205, the named wireless network may be selected for establishing a wireless network connection. The named wireless network may also be entered into the list represented in screen 900 (shown in FIG. 10).

Referring back to FIG. 6, upon identifying the network to establish a wired or wireless network connection, operations of the process may include determining if the selected network is protected by a security protocol in step 512. For example, protocols that subscribe to security standards such as the Wi-Fi Protected Access (WPA) standard, the Wired Equivalent Privacy (WEP) standard or other similar standard may be implemented. If the network is protected, the process may request security information in step 514 that may be provide by the media processing device 205, the network 245 and/or a user. For example, a password may be retrieved from the storage 110 and used to gain access to the network 245. Similarly, a user may provide a password, a security key or other type of security information for gaining access to the network.

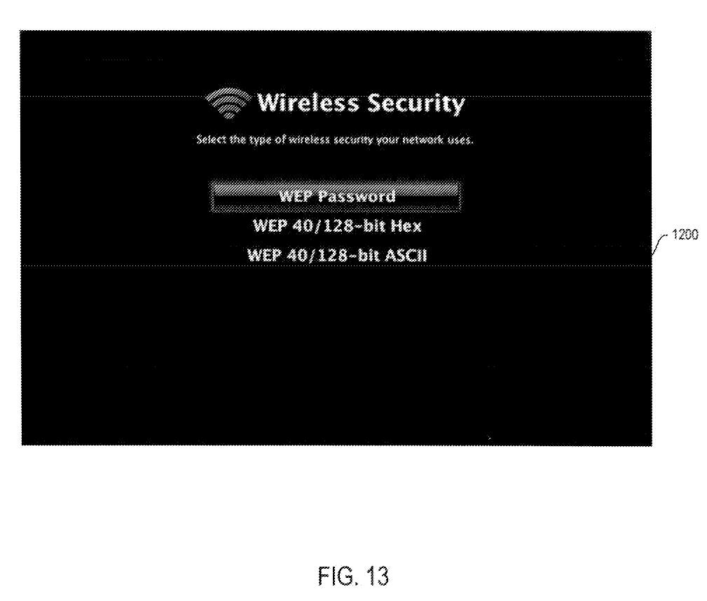

In FIG. 12 a screen 1100 is shown (that may be presented on the display device) for allowing a user provide a password or other type of security information to attain access to a secure network. Similar to the screen 1000 (shown in FIG. 11), a menu of selectable alphanumerical characters and symbols are presented for password entry. Also similar to the screen 1000, a remote control, touch-screen, keyboard, etc. may be used to provide character and symbol selection along with navigation commands. In some implementations, additional information or other information may be needed to attain network access. For example, password format may be selected along with providing the password. In FIG. 13, a screen 1200 is shown that allows a user to select a data format for a WEP password. For example, a 40/128-bit hexadecimal WEP password format may be selected for use in attaining network access or a 40/128 bit ASCII WEB password format may be selected. Other selectable formats and security information (e.g., passwords, keys, etc.) may also be used for attaining network access.

Referring back to FIG. 6, upon requesting security information (if warranted) or determining that the network is not secure, operations of the process include storing one or more settings associated with establishing the wired or wireless network connection in step 516. For example, addresses, passwords, security codes and other types of information may be stored for later retrieval. As such, if the media processing device 205 is toggled between a wired network connection and a wireless network connection, the settings may be retrieved relatively quickly for establishing each respective connection.

Operations of the process also include establishing a communication link with the selected network over the wired or wireless network connection (as determined by the process) in step 518. For example, if a wired network connection is used, signaling and data exchanging (e.g., handshaking) may be executed to establish a communication link. Similarly, wireless signaling and data exchanging may be executed to establish a communication link over a wireless network connection. The process may return to step 502 for continued and repeated monitoring of the wired network connection.

The apparatus, methods, flow diagrams, and structure block diagrams described in this patent document can be implemented in computer processing systems including program code comprising program instructions that are executable by the computer processing system. Other implementations can also be used. Additionally, the flow diagrams and structure block diagrams described in this patent document, which describe particular methods and/or corresponding acts in support of steps and corresponding functions in support of disclosed structural means, can also be utilized to implement corresponding software structures and algorithms, and equivalents thereof.

The apparatus, methods, flow diagrams, and structure block diagrams described in this patent document can be implemented in computer processing systems including program code comprising program instructions that are executable by the computer processing system. Other implementations can also be used. Additionally, the flow diagrams and structure block diagrams described in this patent document, which describe particular methods and/or corresponding acts in support of steps and corresponding functions in support of disclosed structural means, can also be utilized to implement corresponding software structures and algorithms, and equivalents thereof.

The methods and systems described herein may be implemented on many different types of processing devices by program code comprising program instructions that are executable by one or more processors. The software program instructions may include source code, object code, machine code, or any other stored data that is operable to cause a processing system to perform methods described herein.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions and data structures described herein may be connected directly or indirectly to each other in order to allow the flow of data needed for their operations. It is also noted that software instructions or a module can be implemented for example as a subroutine unit of code, or as a software function unit of code, or as an object (as in an object-oriented paradigm), or as an applet, or in a computer script language, or as another type of computer code or firmware. The software components and/or functionality may be located on a single device or distributed across multiple devices depending upon the situation at hand.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art can effect alterations, modifications and variations to the examples without departing from the scope of the invention.

What is claimed is:

1. One or more computer readable media storing instructions that are executable by a processing device, and upon such execution cause the processing device to perform operations comprising:
selecting between a wired network interface of a media processing device and a wireless network interface of the media processing device to establish a connection with a network, wherein the selection is based, at least in part, upon determining if the network is connected to the wired network interface.

2. The computer readable media of claim 1, wherein the wired network interface establishes a communication link with the network if the network is connected to the wired network interface.

3. The computer readable media of claim 1, wherein the wireless network interface establishes a communication link with the network if the network is disconnected from the wired network interface.

4. The computer readable media of claim 1, wherein connection with the wireless network interface is disabled if the network is connected to the wired network interface.

5. The computer readable media of claim 1, wherein connection with the wired network interface is disabled if the network is disconnected from the wired network interface.

6. The computer readable media of claim 1, further comprising instructions to cause the processing device to perform operations comprising:
providing a list of networks available for connection with the media processing device.

7. The computer readable media of claim 6, wherein the list of available networks includes a wireless network.

8. The computer readable media of claim 6, wherein the list is expandable to include a network identified by a user.

9. The computer readable media of claim 1, further comprising instructions to cause the processing device to perform operations comprising:
determining if an address is assigned to the media processing device.

10. The computer readable media of claim 9, wherein the address is assigned using a Dynamic Host Configuration Protocol (DHCP).

11. The computer readable media of claim 1, further comprising instructions to cause the processing device to perform operations comprising:
requesting an address for the media processing device.

12. The computer readable media of claim 1, further comprising instructions to cause the processing device to perform operations comprising:
determining if the network is secure.

13. The computer readable media of claim 1, further comprising instructions to cause the processing device to perform operations comprising:
requesting security information to establish a network connection.

14. The computer readable media of claim 1, further comprising instructions to cause the processing device to perform operations comprising:
storing at least one setting associated with an established network connection between the network and the media processing device.

15. A method comprising:
selecting between a wired network interface of a media processing device and a wireless network interface of the media processing device to establish a connection with a network, wherein the selection is based, at least in part, upon determining if the wired interface is connected to the network;
identifying an address assigned to the media processing device; and
establishing a communication link between the media processing device and the network using the selected network interface.

16. The method of claim 15, wherein the wired network interface establishes a communication link with the network if the network is connected to the wired network interface.

17. The method of claim 15, wherein the wireless network interface establishes a communication link with the network if the network is disconnected from the wired network interface.

18. The method of claim 15, wherein connection with the wireless network interface is disabled if the network is connected to the wired network interface.

19. The method of claim 15, wherein connection with the wired network interface is disabled if the network is disconnected from the wired network interface.

20. The method of claim 15, further comprising:
providing a list of networks available for connection with the media processing device.

21. The method of claim 20, wherein the list of available networks includes a wireless network.

22. The method of claim 20, wherein the list is expandable to include a network identified by a user.

23. The method of claim 15, further comprising:
determining if an address is assigned to the media processing device.

24. The method of claim 23, wherein the address is assigned using a Dynamic Host Configuration Protocol (DHCP).

25. The method of claim 15, further comprising:
requesting an address for the media processing device.

26. The method of claim 15, further comprising:
determining if the network is secure.

27. The method of claim 15, further comprising:
requesting security information to establish a network connection.

28. The method of claim 15, further comprising:
storing at least one setting associated with an established network connection between the network and the media processing device.

29. A media processing device comprising:
a wireless network interface to establish a wireless network connection with a network; and
a wired network interface to establish a wired network connection with the network, wherein the wired network connection is established if the network is connected to the wired network interface.

30. The media processing device of claim 29, wherein the wireless network connection is established if the network is disconnected from the wired network interface.

31. The media processing device of claim 29, wherein the network is selected from a list of available networks.
